(19) United States
(12) Patent Application Publication
(10) Pub. No.: US 2026/0292444 A1
(43) Pub. Date: Sep. 24, 2026

(54) NEURAL NETWORK BASED DETECTION AND TRACKING OF BEYOND VISUAL LINE OF SIGHT UNMANNED AERIAL SYSTEMS

(71) Applicant: Doveka Group Ltd., Burlington (CA)

(72) Inventor: Idris SOULE ALAOFE, Burlington (CA)

(21) Appl. No.: 19/572,182

(22) Filed: Mar. 19, 2026

Related U.S. Application Data
(60) Provisional application No. 63/774,242, filed on Mar. 19, 2025.

(51) Int. Cl. H04W 4/02; G06N 3/0442; G06N 3/0464

(52) U.S. Cl. CPC H04W 4/027; G06N 3/0442; G06N 3/0464

(57) ABSTRACT

A system and method for detecting a beyond visual line of sight unmanned aerial system in a cellular communication network are disclosed. A network-side control module monitors radio communications between a user equipment and a base station, obtains movement-related measurements associated with the user equipment at a plurality of time instants, and forms a movement-pattern time series comprising a time-ordered sequence of feature vectors derived from the movement-related measurements. A trained neural network executes on the movement-pattern time series to generate a classification output indicating whether the user equipment is associated with the beyond visual line of sight unmanned aerial system. In some embodiments, temporal modeling is performed across the movement-pattern time series, and one or more timing-based or frequency-based kinematic estimates are combined with the classification output to generate a fused decision metric.

### PRIORITY CLAIM

The present application claims priority from U.S. provisional Application No. 63/774,242, filed on Mar. 19, 2025, the contents of which are incorporated by reference.

### TECHNICAL FIELD

The disclosure relates generally to wireless communication networks and, more particularly, to network-side detection and classification of user equipment associated with unmanned aerial systems.

### BACKGROUND

Unmanned aerial systems (UAS) are increasingly being deployed in commercial, industrial, governmental, and recreational contexts. In many scenarios, a UAS may carry or otherwise operate with user equipment that communicates through a cellular communication network. Such operation can include beyond visual line of sight (BVLOS) operation, in which the UAS may travel over relatively large distances and may move through radio environments that differ from those associated with terrestrial user equipment.

In some circumstances, a network operator or other authorized entity may seek to determine whether a particular user equipment is associated with a UAS rather than with a terrestrial user or device. Such determinations may be relevant to network management, airspace-related monitoring, safety-related analysis, or other authorized operational functions. However, reliable identification of UAS-associated user equipment can be difficult, particularly when conventional network measurements for airborne and terrestrial devices may overlap at a given instant.

Some approaches for detecting aerial objects rely on visual observation, radar systems, or other external sensing platforms. Although such approaches may be useful in some environments, they may be limited by line-of-sight conditions, clutter, range, resolution, deployment cost, or incomplete integration with the cellular communication network. As a result, such approaches may not readily provide network-side visibility into whether a particular user equipment communicating with a base station is being operated onboard a UAS.

Within a cellular communication network, radio communications between a user equipment and one or more base stations may include information that is indicative of motion of the user equipment relative to the network. However, distinguishing user equipment associated with a BVLOS UAS from terrestrial user equipment based solely on isolated or instantaneous measurements may remain difficult. Different device types and usage scenarios may exhibit similar measurement values at individual time instants, while the underlying movement behavior over time may differ.

Accordingly, a need exists for network-side techniques that use information derived from radio communications over time to improve detection and classification of user equipment associated with UAS operation, including BVLOS UAS operation, in a cellular communication network.

### SUMMARY

According to an aspect of the present disclosure, a computer-implemented method of detecting a beyond visual line of sight (BVLOS) unmanned aerial system (UAS) in a cellular communication network comprises monitoring, by one or more processors of a network-side control module, radio communications between a user equipment (UE) and a base station of the cellular communication network, the UE being camped on, registered with, or connected to the base station; obtaining, at each of a plurality of time instants and based at least in part on the radio communications, movement-related measurements associated with the UE; forming, by the network-side control module, a movement-pattern time series comprising a time-ordered sequence of feature vectors derived from the movement-related measurements; executing, by the network-side control module, a trained neural network using the movement-pattern time series as input to generate a classification output indicating whether the UE is associated with the BVLOS UAS; and classifying, by the network-side control module, the UE as associated with the BVLOS UAS based on the classification output.

According to some embodiments, the cellular communication network can comprise one or more of a Long Term Evolution (LTE) network and a Fifth Generation New Radio (5G-NR) network.

According to some embodiments, obtaining the movement-related measurements can comprise obtaining, from the radio communications, one or more measurements selected from timing advance (TA), a TA delta, a round-trip time, a carrier frequency offset (CFO), a Doppler shift estimate, a reference signal measurement, a beam index, a mobility indicator, a handover indicator, an uplink power control metric, an uplink power headroom metric, reference signal received power (RSRP), reference signal received quality (RSRQ), a signal-to-interference-plus-noise ratio (SINR), and a signal-to-noise ratio (SNR).

According to some embodiments, a feature vector can comprise one or more derived kinematic features selected from range, range-rate, radial velocity, acceleration, altitude, vertical velocity, altitude change, and a velocity change.

According to some embodiments, forming the movement-pattern time series can comprise forming a sliding window comprising N sequential samples of the feature vectors, wherein N is 2 or more.

According to some embodiments, the sliding window can comprise 10 or more samples and no more than 500 samples.

According to some embodiments, executing the trained neural network can comprise performing temporal modeling across the time-ordered sequence of feature vectors to identify temporal dependencies indicative of a movement pattern associated with the BVLOS UAS.

According to some embodiments, the trained neural network may comprise a sequence model selected from a long short-term memory (LSTM) network, a gated recurrent unit (GRU) network, a temporal convolutional network (TCN), and a transformer-based attention network.

According to some embodiments, classifying the UE as associated with the BVLOS UAS may comprise applying temporal smoothing or hysteresis by requiring persistence of the classification output across a plurality of sliding windows.

According to some embodiments, the trained neural network may comprise a convolutional neural network (CNN) and a sequence model, and an output of the CNN may be provided as an input to the sequence model.

According to some embodiments, the sequence model may comprise an LSTM network, and the CNN may perform one-dimensional convolutions over the feature vectors in the movement-pattern time series.

According to some embodiments, the method may further comprise deriving, from a timing-based measurement obtained from the radio communications, a timing-based kinematic estimate indicative of a range or a range-rate of the UE relative to the base station.

According to some embodiments, the timing-based measurement may comprise timing advance (TA), and the timing-based kinematic estimate may comprise a distance change or a range-rate derived from a TA delta.

According to some embodiments, the method may further comprise deriving, from a frequency-based measurement obtained from the radio communications, a frequency-based kinematic estimate indicative of a radial velocity of the UE relative to the base station.

According to some embodiments, the frequency-based measurement may comprise a carrier frequency offset (CFO) and/or a Doppler shift estimate.

According to some embodiments, the method may further comprise generating a physics-based kinematic estimate based on at least two distinct radio measurement sources comprising a timing-based measurement and a frequency-based measurement; and generating a fused decision metric by combining the physics-based kinematic estimate and the classification output of the trained neural network, wherein classifying the UE as associated with the BVLOS UAS may be based on the fused decision metric.

According to an aspect of the present disclosure, a radio access network server comprises one or more processors and a memory storing instructions that, when executed by the one or more processors, cause the radio access network server to perform operations comprising monitoring radio communications between a user equipment (UE) and a base station of a cellular communication network, the UE being camped on, registered with, or connected to the base station; obtaining, at each of a plurality of time instants and based at least in part on the radio communications, movement-related measurements associated with the UE; forming a movement-pattern time series comprising a time-ordered sequence of feature vectors derived from the movement-related measurements; executing a trained neural network using the movement-pattern time series as input to generate a classification output indicating whether the UE is associated with a beyond visual line of sight (BVLOS) unmanned aerial system (UAS); and classifying the UE as associated with the BVLOS UAS based on the classification output.

According to some embodiments, the cellular communication network may comprise at least one of a Long Term Evolution (LTE) network and a Fifth Generation New Radio (5G-NR) network.

According to some embodiments, the operations may comprise performing temporal modeling across the movement-pattern time series to identify temporal dependencies indicative of a movement pattern associated with the BVLOS UAS.

According to some embodiments, the trained neural network may comprise a sequence model selected from an LSTM network, a GRU network, a TCN, and a transformer-based attention network.

According to some embodiments, the trained neural network may comprise a CNN and an LSTM, and an output of the CNN may be provided as an input to the LSTM.

According to some embodiments, the operations may further comprise deriving a timing-based kinematic estimate from timing advance (TA) and deriving a frequency-based kinematic estimate from a carrier frequency offset (CFO) and/or a Doppler shift estimate.

According to some embodiments, the operations may further comprise generating a fused decision metric by combining a physics-based kinematic estimate with the classification output of the trained neural network, and weighting the combining based on one or more confidence values derived from at least one radio signal quality metric selected from SINR, RSRP, and RSRQ.

According to some embodiments, the operations may further comprise, responsive to classifying the UE as associated with the BVLOS UAS, causing a network-side mitigation action selected from access restriction, throttling, uplink resource restriction, handover restriction, radio resource control (RRC) release, and session termination.

According to an aspect of the present disclosure, a non-transitory computer-readable storage medium stores instructions that, when executed by one or more processors of a network-side control module, cause the one or more processors to perform operations comprising monitoring radio communications between a user equipment (UE) and a base station of a cellular communication network, the UE being camped on, registered with, or connected to the base station; obtaining, at each of a plurality of time instants and based at least in part on the radio communications, movement-related measurements associated with the UE; forming a movement-pattern time series comprising a time-ordered sequence of feature vectors derived from the movement-related measurements; executing a trained neural network using the movement-pattern time series as input to generate a classification output indicating whether the UE is associated with a beyond visual line of sight (BVLOS) unmanned aerial system (UAS); and classifying the UE as associated with the BVLOS UAS based on the classification output.

According to some embodiments, executing the trained neural network may comprise performing temporal modeling across the movement-pattern time series.

According to some embodiments, the trained neural network may comprise a CNN and a sequence model, and an output of the CNN may be provided as an input to the sequence model.

According to some embodiments, the operations may further comprise deriving timing advance (TA) and a carrier frequency offset (CFO) and/or a Doppler shift estimate from the radio communications and generating a fused decision metric by combining a physics-based kinematic estimate derived therefrom with the classification output.

According to an aspect of the present disclosure, a computer-implemented method of training a neural network for classifying a user equipment (UE) as associated with a beyond visual line of sight (BVLOS) unmanned aerial system (UAS) in a cellular communication network comprises obtaining, by one or more processors of a training computing system, training examples, each training example comprising a labeled movement-pattern time series derived from radio communications between a UE and a base station, each movement-pattern time series comprising a time-ordered sequence of feature vectors derived from movement-related measurements associated with the UE; and training, by the training computing system, the neural network using the training examples by adjusting weights of the neural network using backpropagation to reduce a classification loss.

According to some embodiments, the labeled movement-pattern time series may be labeled based on ground truth sources comprising at least one of controlled UAS flight telemetry, global navigation satellite system (GNSS) logs, inertial measurement unit (IMU) logs, cooperative UAS identifiers, and synchronized test range instrumentation, and negative training examples may comprise movement-pattern time series for non-UAS UEs operating in terrestrial scenarios.

### BRIEF DESCRIPTION OF THE DRAWINGS

FIG. 1 depicts, in an example embodiment, a machine learning neural network-based system for detection and tracking of a beyond visual line of sight (BVLOS) UAS in a cellular communication network.

FIG. 2 depicts, in an example embodiment, an architecture of a control module in accordance with a machine learning neural network-based system for detection and tracking of a BVLOS UAS in a cellular communication network.

FIG. 3 depicts, in an example embodiment, a scheme for deploying a machine learning neural network-based system for detection and tracking of a BVLOS UAS in a cellular communication network.

FIG. 4 depicts, in an example embodiment, a communication signal based scheme for providing physical height measurements related to detection and tracking of a BVLOS UAS in a cellular communication network.

FIG. 5 depicts, in an example embodiment, a method of detecting a BVLOS UAS in a cellular communication network based at least partly on a machine learning neural network system.

FIG. 6 depicts, in an example embodiment, a method of training a machine learning neural network system in detection and tracking of a BVLOS UAS in a cellular communication network.

FIG. 7 illustrates, in an example embodiment, a method of operation for a network-side mitigation process related to detection of a user equipment associated with an unmanned aerial system in a cellular communication network.

FIG. 8 illustrates, in an example embodiment, a network-side mitigation policy for implementing operator-controlled mitigation or verification actions responsive to detection of a user equipment associated with an unmanned aerial system.

FIG. 9 depicts, in an example embodiment, time-series windowing and buffer feeding of feature vectors to a neural network.

FIG. 10 depicts, in an example embodiment, network-side measurement extraction points and per-time-step feature vector formation.

FIG. 11 depicts, in an example embodiment, weighted fusion of physics-based estimates and neural-network output leading to a detection decision.

FIG. 12 depicts, in an example embodiment, an end-to-end training pipeline for generating and deploying a trained neural network model.

FIG. 13 depicts, in an example embodiment, a geometry-based arrangement for estimating an altitude-related quantity of a user equipment.

FIG. 14 depicts, in an example embodiment, a call flow for measurement acquisition and movement-pattern time-series formation.

FIG. 15 depicts, in an example embodiment, continuity of user-equipment identity and track association across handover between cells.

FIG. 16 depicts, in an example embodiment, feature engineering from raw radio measurements to derived kinematic features.

FIG. 17 depicts, in an example embodiment, decision logic using temporal smoothing and hysteresis.

FIG. 18 depicts, in an example embodiment, a tracking-state estimator update loop.

FIG. 19 depicts, in an example embodiment, alternative deployment architectures for a network-side control module.

FIG. 20 depicts, in an example embodiment, a network-side mitigation policy and control loop.

### DETAILED DESCRIPTION

Embodiments described herein provide systems and methods for detecting, classifying, and, in some embodiments, tracking a user equipment associated with an unmanned aerial system in a cellular communication network. In some embodiments, the disclosed techniques may be implemented in a network-side control module 105 executed by one or more processors of a radio access network server 103, a base station 101, a centralized or distributed network element, an edge-computing platform, or another network-side computing system in communication with a radio access network. The cellular communication network 100 may comprise, by way of example, a Long Term Evolution network (LTE), a Fifth Generation New Radio network (5G), or another wireless communication network.

In some embodiments, the control module 105 monitors radio communications between a user equipment and one or more base stations and obtains movement-related measurements associated with the user equipment at a plurality of time instants. The movement-related measurements may include raw radio measurements, derived kinematic quantities, or both. The control module 105 may form a movement-pattern time series comprising a time-ordered sequence of feature vectors derived from the movement-related measurements and may execute a trained neural network using the movement-pattern time series as input to generate one or more classification outputs indicating whether the user equipment is associated with an unmanned aerial system, whether the user equipment is airborne, and whether the operation is beyond visual line of sight.

In some embodiments, temporal modeling of the movement-pattern time series enables the disclosed system to distinguish movement behavior associated with airborne operation from movement behavior associated with terrestrial user equipment. The trained neural network may comprise any suitable sequence-processing architecture, including a long short-term memory network, a gated recurrent unit network, a temporal convolutional network, a transformer-based attention network, or a hybrid arrangement thereof. In some embodiments, the trained neural network comprises a convolutional neural network configured to extract local features from the time-ordered sequence and a sequence model configured to model temporal dependencies across the sequence.

In some embodiments, the disclosed system may additionally derive one or more timing-based and frequency-based kinematic estimates from uplink measurements and may combine such estimates with one or more outputs of the trained neural network to generate a fused decision metric. In some embodiments, the disclosed system may further maintain a track state associated with the user equipment and may update the track state over time, including across handover between cells.

Also provided are radio access network servers, non-transitory computer-readable storage media, and training methods configured to implement the disclosed techniques. In some embodiments, the training methods use labeled movement-pattern time series derived from radio communications between user equipment and one or more base stations and ground-truth data indicating whether the user equipment is associated with an unmanned aerial system, whether the user equipment is airborne, and whether the operation is beyond visual line of sight.

Further provided is a non-transitory computer-readable storage medium storing instructions that, when executed by one or more processors of a network-side control module, cause the one or more processors to perform operations comprising monitoring radio communications between a user equipment and a base station of a cellular communication network, the user equipment being camped on, registered with, or connected to the base station; obtaining, at each of a plurality of time instants and based at least in part on the radio communications, movement-related measurements associated with the user equipment; forming a movement-pattern time series comprising a time-ordered sequence of feature vectors derived from the movement-related measurements; executing a trained neural network using the movement-pattern time series as input to generate a classification output indicating whether the user equipment is associated with a beyond visual line of sight unmanned aerial system; and classifying the user equipment as associated with the beyond visual line of sight unmanned aerial system based on the classification output.

In some embodiments, the convolutional neural network performs one-dimensional convolutions along a time dimension of the movement-pattern time series.

In some embodiments, the operator-controlled mitigation or verification actions may further include termination, or causing termination, of a session associated with the user equipment.

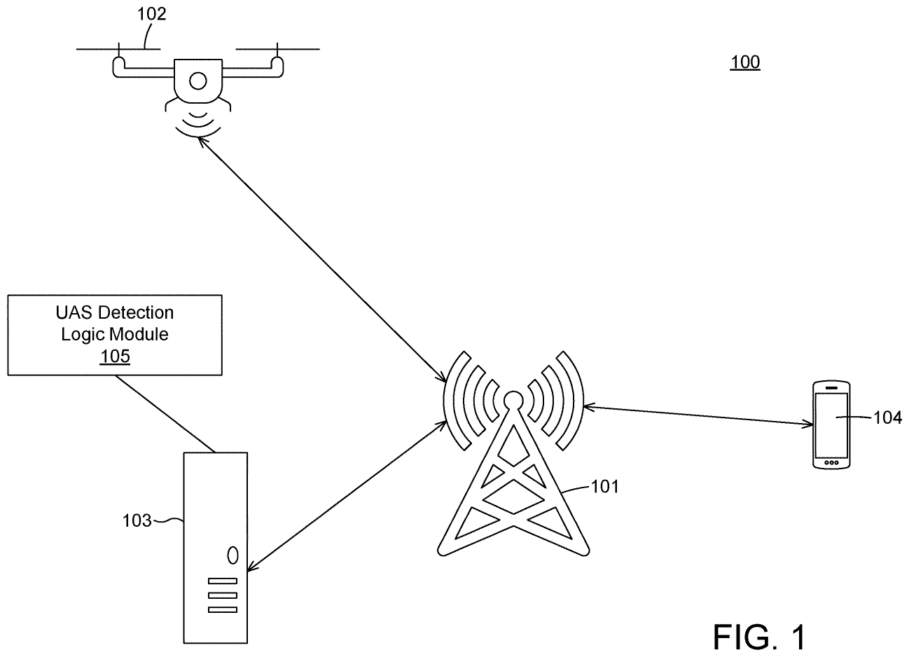

FIG. 1 illustrates, in an example embodiment, a machine learning neural network-based system for detection and tracking of UAS 102 in cellular communication network 100. In embodiments, machine learning based cellular communication network 100 includes base station (eNB) 101 communicatively coupled to radio access server computing system 103 and to user equipment (UE) 104, 102. As used herein, UAS 102 refers to a particular UE case that constitutes a BVLOS UAS. Radio access server computing system 103 provides executable logic instructions constituting a control module for deployment within cellular communication network 100. Base station 101 is in wireless radio frequency (RF) communication with any number of UE's, including UE's 102, 104. In embodiments, radio access server computing system 103 incorporates executable logic instructions that comprise UAS detection logic module 105. In some embodiments, is contemplated that the logic instructions that constitute UAS detection logic module 105 may be hosted, partially or otherwise, in other computing or server system communicatively coupled to server computing system 103 within, or communicatively accessible to, cellular communication system 100, as will be apparent to those of skill in the art of computer and communication networks. In a particular embodiment, cellular communication system 100 may be a 5G network implementation.

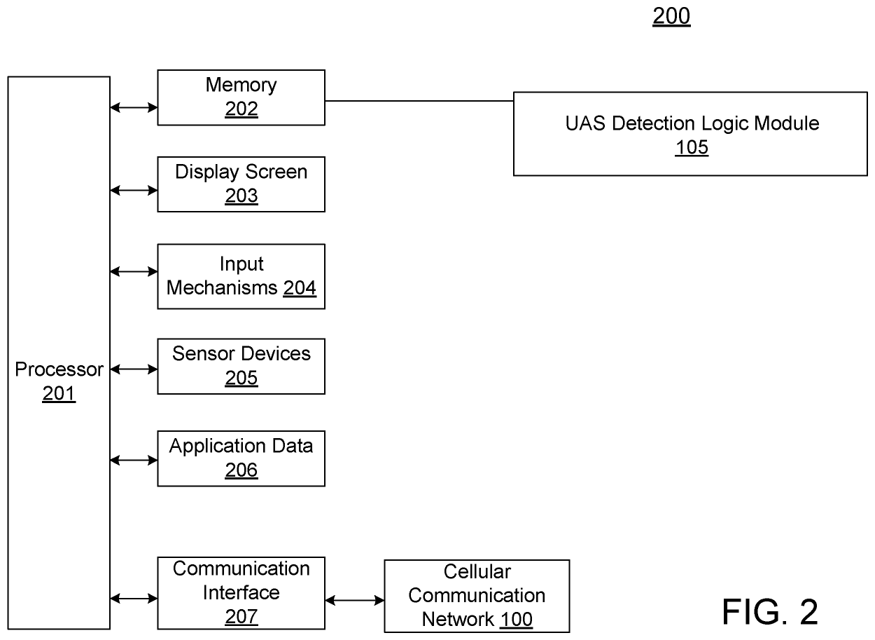

FIG. 2 illustrates, in an example embodiment, architecture 200 of a computer control module in accordance with a machine learning neural network-based system for detection and tracking of UAS 102 in cellular communication network 100. Architecture 200, in embodiments, may be implemented on, for example, a server or combination of servers, or reside on base communication station 101. In one implementation, architecture 200 includes processor 201, memory resources 202 (e.g., read-only memory (ROM) or random-access memory (RAM), and communication interface 207 communicatively coupled within cellular communication system 100. Memory resources 202 may include instructions, constituting UAS detection logic module 105, that are executable in processor 201. Memory resources 202 may also be used to store temporary variables or other intermediate information during execution of program instructions by processor 201.

Architecture 200 may include display screen 203 and input mechanisms 204. As described by various examples, processor 201 can detect and process any number of sensor inputs from input sensor devices 205. By way of example, such sensor inputs can include, but are not necessarily limited to, various sensor devices providing physical parameter measurements related to timing of signals as received from cellular communications, and RF signal characteristics in relation thereto.

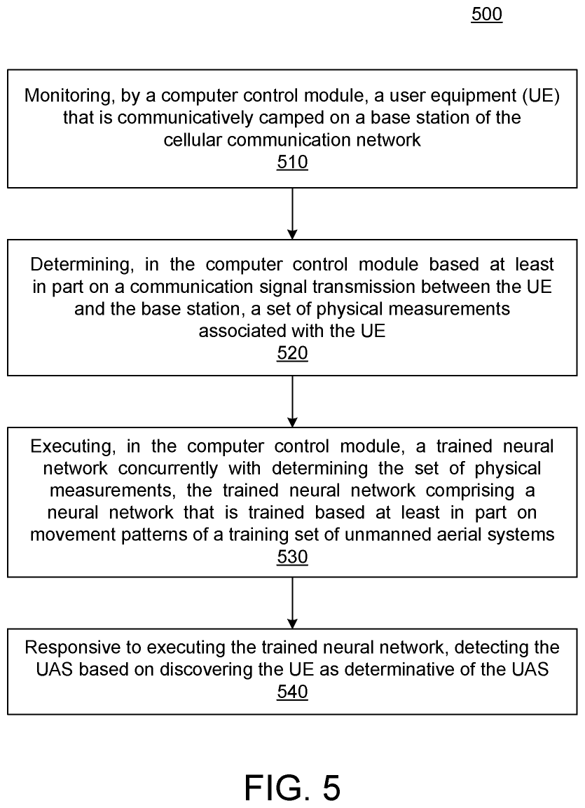

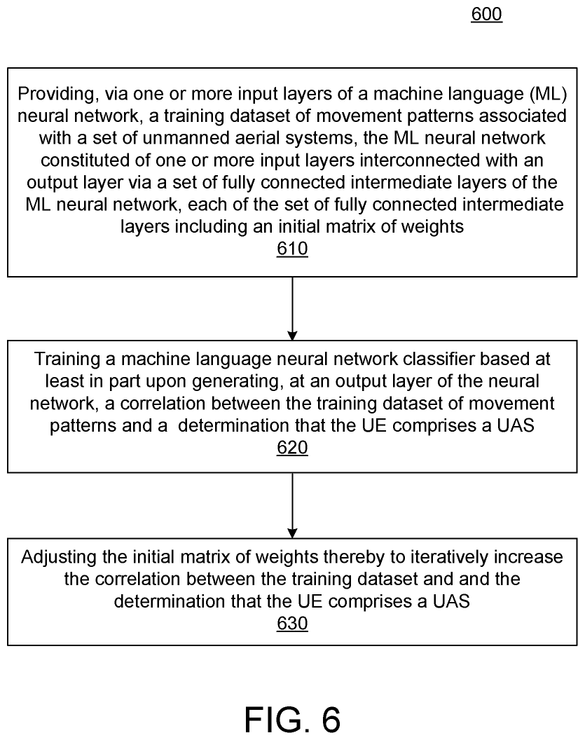

As such, examples described herein are related to the use of the computer system 200 for implementing the techniques described herein. According to an aspect, techniques are performed by way of architecture 200 in response to the processor 201 executing one or more sequences of one or more instructions contained in memory 202. Such instructions may be read into memory 202 from another machine-readable medium. Execution of the sequences of instructions contained in memory 202 causes the processor 201 to perform the process steps described herein, including process steps of the embodiments and systems described herein in conjunction with, for example, the embodiments as described in FIGS. 1-8 herein. In alternative implementations, hard-wired circuitry may be used in place of or in combination with software instructions to implement examples described herein. Thus, the examples described are not limited to any specific combination of hardware circuitry and software.

In some embodiments, communication interface 207 provides bi-directional communication and computing accessibility between server computing system 103, including UAS detection logic module 105 constituted therein, and other devices and systems of cellular communication system 100 as depicted in FIGS. 1-8 and described herein.

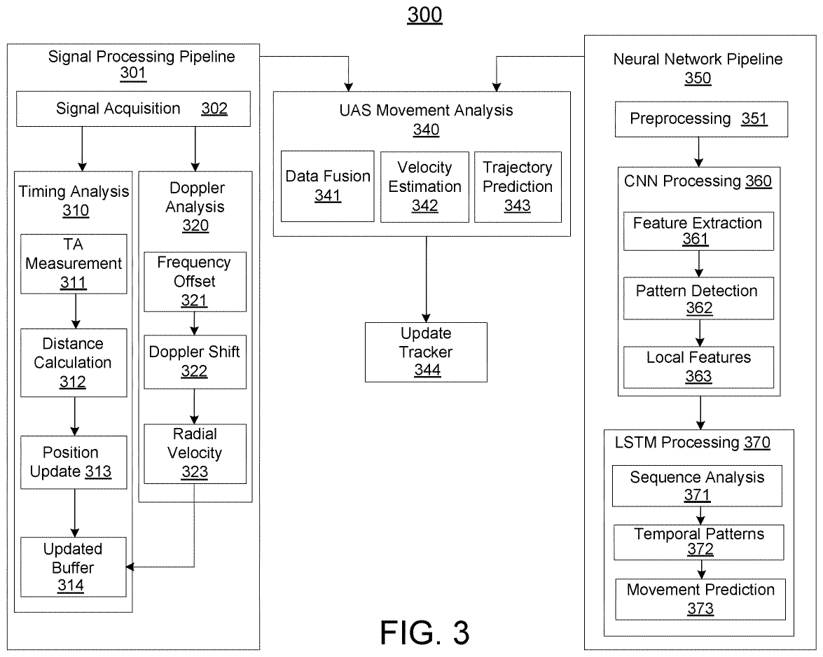

FIG. 3 illustrates, in an example embodiment, scheme 300 for deploying a machine learning neural network-based system for detection and tracking of UAS 102 in cellular communication network 100. Examples of method steps described herein are related to deployment and use of machine learning based cellular communication network 100 as described herein, in conjunction with any of the techniques, method steps, devices and systems, or portions thereof, as described in regard to FIGS. 1-8 herein. According to one embodiment, the techniques are performed in processor 201 executing one or more sequences of software logic instructions that constitute UAS detection logic module 105. In embodiments, instructions constituting UAS detection logic module 105 may be read into memory 202 from machine-readable medium, such as memory storage devices. Executing the instructions of UAS detection logic module 105 stored in memory 202 causes processor 201 to perform the process steps described herein.

In an embodiment, UAS detection logic module 105, in control module of a radio access network server that incorporated architecture 200, may be constituted in a software defined radio (SDR) configuration, the SDR being embedded in a semiconductor integrated circuit (IC) device of the control module. In alternative implementations, at least some hard-wired circuitry, including but not limited to field programmable gate array (FPGA) implementations, may be used in place of, or partly in combination with, the software logic instructions that constitute UAS detection logic module 105 in order to implement example embodiments described herein. Thus, the examples described herein are not limited to any particular combination of hardware circuitry and software instructions.

In some embodiments, the control module 105 forms, from measurements obtained at successive sampling intervals, a movement-pattern time series for a particular user equipment. Each time step may be represented by a feature vector that includes raw radio measurements, derived kinematic quantities, or both. By way of non-limiting example, the raw radio measurements may include one or more of timing advance, timing-advance change, carrier frequency offset, Doppler shift estimate, uplink reference signal received power, reference signal received quality, signal-to-interference-plus-noise ratio, signal-to-noise ratio, beam identifier, cell identifier, handover indicator, uplink power control metrics, uplink power headroom metrics, or other mobility-related indicators. Derived quantities may include one or more of range, range rate, radial velocity, acceleration, altitude, altitude change, vertical velocity, or velocity change. In some embodiments, the per-time-step feature vector may include a combination of timing-based measurements, frequency-based measurements, signal-quality measurements, and one or more identifiers or flags associated with cell context.

In some embodiments, the movement-pattern time series is formed as a fixed-length or variable-length sequence of feature vectors sampled at a selected cadence. The cadence may be selected according to network configuration, measurement availability, processing budget, or desired responsiveness and may, by way of example, correspond to intervals in a range from 20 milliseconds to 100 milliseconds. The control module 105 may store the feature vectors in a buffer and may segment the buffered sequence into windows for inference. A window may include a plurality of sequential samples and may optionally overlap with one or more adjacent windows. In some embodiments, a window may include from 50 to 200 time steps, although other lengths may be used. A stride may be selected to provide non-overlapping windows or overlapping windows, including, by way of example, a stride equal to approximately one-half of the window length.

In some embodiments, missing or unavailable measurements may be handled by discarding windows having more than a threshold proportion of missing samples and by retaining windows having no more than the threshold proportion of missing samples. For retained windows, one or more missing samples may be filled with a placeholder value, such as zero or another selected substitute value, and an additional validity indicator or mask channel may be appended so that the neural network can distinguish valid samples from missing samples. In some embodiments, the threshold proportion may be approximately twenty-five percent, although other thresholds may be used.

In some embodiments, timing-based and frequency-based measurements are obtained from uplink communications at a radio access network vantage point. For example, timing-related measurements may be obtained from uplink random access signals, sounding reference signals, demodulation reference signals, other uplink reference signals, or layer-1 measurement reports generated therefrom. Frequency-related measurements, including carrier frequency offset estimates and Doppler-related estimates, may likewise be obtained from uplink reference signals, including sounding reference signals and demodulation reference signals associated with uplink shared-channel or uplink control-channel transmissions. In this manner, the disclosed system may operate using measurements available at an eNB, a gNB, a distributed unit, a centralized unit, a near-real-time controller, an edge server, or another network-side processing location.

In some embodiments directed to Long Term Evolution operation, one timing advance step may correspond to sixteen basic time units, where Tₛ=1/(15000×2048) seconds. In some embodiments directed to New Radio operation, timing-related quantities may be obtained using corresponding New Radio timing definitions and layer-1 measurement reports. For New Radio deployments, sounding reference signal configuration may depend on the bandwidth part or other radio configuration, and the control module 105 may use gNB measurement reports or equivalent internal measurements to obtain the timing-based and frequency-based inputs used by the detection pipeline.

In some embodiments, temporal modeling may be carried out by any suitable sequence-processing architecture. The trained neural network may comprise, by way of example, a recurrent neural network, a long short-term memory network, a gated recurrent unit network, a temporal convolutional network, a transformer-based sequence model, or a hybrid arrangement thereof. In some embodiments, a convolutional stage performs local feature extraction across the sequence and provides extracted features to a recurrent or other temporal stage that models dependencies across time. In particular embodiments, the trained neural network comprises a convolutional neural network and a long short-term memory network arranged such that an output of the convolutional neural network is provided as an input to the long short-term memory network.

In some embodiments, the control module 105 may generate a fused decision metric by combining one or more physics-based kinematic estimates with one or more outputs of the trained neural network. By way of example, a timing-based estimate, such as a range-rate estimate derived from timing advance or timing-advance change, may be combined with a frequency-based estimate, such as a radial-velocity estimate derived from carrier frequency offset or Doppler information, and with a neural-network classification score or probability. The combining operation may be performed on a per-sample basis, on a per-window basis, or in a hierarchical manner in which per-sample quantities are aggregated over a window before a final decision is produced.

In some embodiments, the contributions of the different sources may be weighted according to confidence values. The confidence values may be determined from one or more radio-quality metrics, from estimated variances of the respective sources, from handover status, from neural-network output confidence, or from combinations thereof. For example, a source associated with higher signal quality may be assigned a larger weight, while a source associated with a handover event, degraded radio conditions, or elevated uncertainty may be downweighted or temporarily ignored. The resulting fused score may be compared with one or more thresholds to determine whether the user equipment is to be classified as associated with an unmanned aerial system, airborne, or operating beyond visual line of sight.

In some embodiments, a temporal persistence rule, hysteresis rule, or state machine may be applied to successive windows in order to reduce false detections. For example, the control module 105 may require that a detection condition be satisfied for a selected number of consecutive windows before transitioning from a cleared state to a suspected state or a confirmed state. Likewise, the control module 105 may require that a clearing condition be satisfied for a selected number of consecutive windows before returning to a non-detected state. Such temporal smoothing may improve robustness in the presence of transient radio fluctuations.

In some embodiments, the disclosed system may further maintain a track state for a user equipment and may update the track state using a state estimator. The state estimator may comprise, by way of example, a Kalman filter, an extended Kalman filter, an unscented Kalman filter, a particle filter, or another recursive estimator. A state vector may include position, velocity, acceleration, or combinations thereof, including two-dimensional or three-dimensional position and corresponding velocity components. A measurement vector may include one or more of a timing-based range estimate, a frequency-based radial-velocity estimate, an uplink received-power measurement, or other radio-derived observations. In some embodiments, the prediction step may be based on a constant-velocity or constant-acceleration motion model, and process-noise and measurement-noise terms may be selected according to expected mobility characteristics and radio conditions.

In some embodiments, continuity of a user-equipment track across handover may be maintained using temporary identifiers, session context, forwarded mobility context, or combinations thereof. By way of example, a first cell-specific identifier may be replaced with a second cell-specific identifier at handover while a broader temporary identity is preserved or forwarded between source and target network elements. The control module 105 may evaluate whether a post-handover measurement is sufficiently consistent with a predicted pre-handover track state, including by transforming the predicted state to a target-cell reference frame and applying a gating test. If the gating test is satisfied, the track may be continued and the timing reference may be reinitialized relative to the target cell. Otherwise, a new track may be created.

Communication signal processing scheme 301 provides physical measurements related to detection and tracking of a beyond visual line of sight UAS in cellular communication network 100, based on signal acquisition 302. Signal acquisition 302 is applied to timing analysis 310, fed sequentially into TA measurement 311, distance calculation 312, position update 313 and updated buffer 314. Signal acquisition 302 further is applied to Doppler analysis 320, frequency offset 321, Doppler shift, and radial velocity 323 modules sequentially, with results of radial velocity merged into buffer update 314 module.

Neural network pipeline scheme 350 shows, in an embodiment, a machine learning neural network-based system deployed in detection and tracking of a beyond visual line of sight UAS 102 in cellular communication network 100. Neural network pipeline 350 includes preprocessing 351 of UAS training datasets, convolution neural network (CNN) processing 360, feature extraction 362, pattern detection 362 and local features 363. Output of CNN processing 360 is fed into long short-term memory (LSTM) processing 370, which includes sequence analysis 371, temporal patterns 372 and movement prediction 373 modules. In embodiments, the AI neural network comprises a fusion of the convolutional neural network (CNN) and the long short term memory (LSTM) neural network. The CNN performs spatial feature extraction, and the LSTM neural network captures temporal dependencies. In some aspects, the fusion comprises sequentially feeding the output of the CNN as input into the LSTM network, enabling the AI neural network to contemporaneously learn spatial and temporal features of the movement patterns. In particular embodiments, the fusion of the convolutional neural network (CNN) and the long short term memory (LSTM) neural network is implemented by sequentially feeding the output of the CNN as input into the LSTM network, thereby enabling the AI neural network to contemporaneously learn spatial and temporal features of the movement patterns.

Results from concurrent execution of communication signal processing 301 and neural network pipeline 350 are provided to UAS movement analysis 340, and includes data fusion 341, velocity estimation 342 and trajectory prediction 343 modules, to accomplish UAS tracking functionality via updated tracker 344.

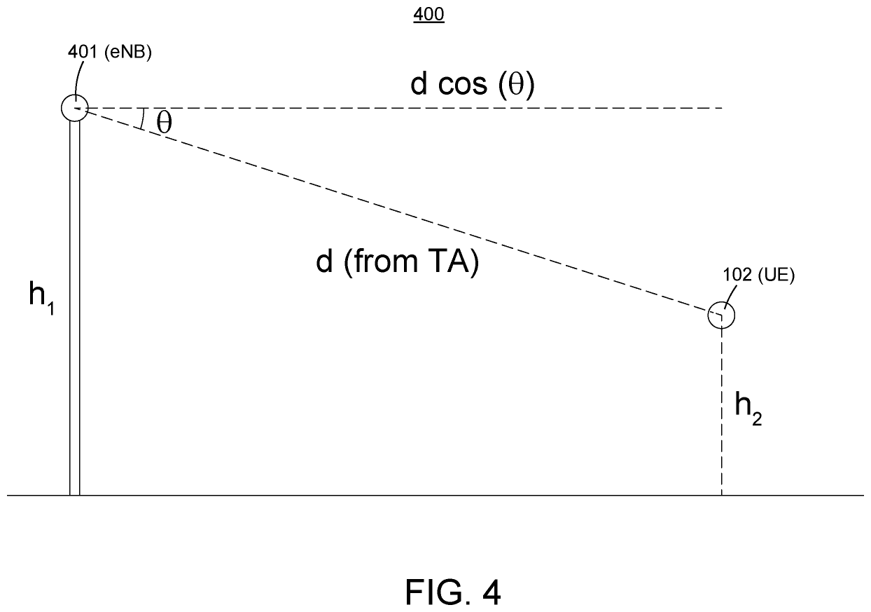

In some embodiments, FIG. 4 illustrates a geometry-based arrangement for estimating altitude or relative height of a user equipment 102 with respect to a base station 101. The altitude information may be used in conjunction with one or more timing-based measurements, frequency-based measurements, and neural-network outputs to distinguish airborne operation from terrestrial operation.

In some embodiments, a slant range between the base station 101 and the user equipment 102 may be estimated from a timing-based measurement, such as timing advance or another round-trip timing quantity. In some embodiments, an elevation-related quantity may be obtained from beam-management information, a beam index, antenna geometry, antenna electrical tilt, channel-state information, or another angle-related indicator available within the network. Using a known or estimated base-station height 401, a slant range 400, and an elevation angle 402, the control module 105 may estimate an altitude-related quantity for the user equipment 102. By way of example, if d denotes the slant range, h₁ denotes the base-station height, and θ denotes the elevation angle, the estimated user-equipment height h₂ may be expressed as h₂=h₁+d sin (θ). A corresponding horizontal range component may be expressed as d cos (θ).

In some embodiments, the altitude-related quantity may be used as an input feature of the trained neural network, as an input to a fused decision metric, as an input to a tracking filter, or as part of a rule-based discriminator used together with one or more other movement-related measurements.

At step 510, the control module 105 monitors radio communications between a user equipment and a base station of the cellular communication network. In some embodiments, the monitored communications include uplink communications from which network-side measurements may be obtained at a radio access network vantage point. The user equipment may be camped on, registered with, or connected to the base station. In some embodiments, the control module 105 may receive or access measurements generated by an eNB or gNB receiver, a distributed unit, a centralized unit, or another network-side processing function.

At step 520, the control module 105 obtains movement-related measurements associated with the user equipment at a plurality of time instants and forms a movement-pattern time series comprising a time-ordered sequence of feature vectors derived from the movement-related measurements. In some embodiments, the movement-related measurements may comprise one or more of timing advance, timing-advance change, round-trip timing information, carrier frequency offset, Doppler-related information, reference signal measurements, beam information, signal-quality metrics, uplink power-control metrics, handover indicators, cell identifiers, range estimates, range-rate estimates, radial velocity estimates, acceleration estimates, altitude estimates, or other movement-related quantities.

At step 530, the control module 105 executes a trained neural network using one or more windows of the movement-pattern time series as input. In some embodiments, the trained neural network performs temporal modeling across the time-ordered sequence of feature vectors to identify temporal dependencies indicative of a movement pattern associated with airborne or beyond visual line of sight operation. The trained neural network may comprise a sequence model, including a long short-term memory network, a gated recurrent unit network, a temporal convolutional network, a transformer-based attention network, or another temporal model. In some embodiments, the trained neural network comprises a convolutional neural network configured to extract local features from the sequence and a sequence model configured to process temporal dependencies across the sequence.

At step 540, the control module 105 generates one or more classification outputs and classifies the user equipment based on the classification outputs. In some embodiments, the control module 105 determines whether the user equipment is associated with an unmanned aerial system, whether the user equipment is airborne, whether the operation is beyond visual line of sight, or combinations thereof. In some embodiments, the classification may be based solely on the output of the trained neural network. In other embodiments, the classification may further be based on a fused decision metric that combines a neural-network output with one or more timing-based or frequency-based kinematic estimates. In some embodiments, temporal smoothing or hysteresis is applied across multiple windows before a detection state is confirmed.

In embodiments, the communication signal transmission between the UE and the base station comprises an uplink channel that transmits data from the UE to the base station in accordance with Frequency-Division Duplexing LTE and 5G New Radio (5G-NR) radio bands.

In embodiments, the AI neural network comprises a fusion of a convolutional neural network (CNN) and a long short term memory (LSTM) neural network. The CNN performs spatial feature extraction and the LSTM neural network captures temporal dependencies. In some aspects, the fusion comprises sequentially feeding the output of the CNN as input into the LSTM network, enabling the AI neural network to contemporaneously learn spatial and temporal features of the movement patterns. In particular embodiments, the fusion of the convolutional neural network (CNN) and the long short term memory (LSTM) neural network is implemented by sequentially feeding the output of the CNN as input into the LSTM network, thereby enabling the AI neural network to contemporaneously learn spatial and temporal features of the movement patterns.

At step 610, one or more processors of a training computing system obtain training examples for training a neural network classifier. In some embodiments, each training example comprises a labeled movement-pattern time series corresponding to a window of sequential feature vectors derived from radio communications between a user equipment and one or more base stations. Each feature vector may include raw radio measurements, derived kinematic quantities, or both. By way of example, the feature vectors may include timing advance, timing-advance change, carrier frequency offset, one or more radio-quality metrics, a cell identifier, one or more beam-related quantities, a radial-velocity estimate, an altitude-related estimate, or other movement-related information.

In some embodiments, the movement-pattern time series is segmented into fixed-length windows or variable-length windows for training. A window may include a selected number of time steps, and adjacent windows may overlap according to a selected stride. In some embodiments, labels may be assigned on a per-window basis according to a majority vote or another aggregation of a ground-truth state across the time steps included in the window.

In some embodiments, labels may be generated using one or more ground-truth sources, including controlled unmanned aerial system flight telemetry, global navigation satellite system logs, inertial measurement unit logs, cooperative unmanned aerial system identifiers, synchronized test-range instrumentation, visual confirmation, airspace-management data, or combinations thereof. Negative training examples may include terrestrial user-equipment recordings obtained from handheld devices, vehicle-mounted devices, fixed wireless devices, or other non-aerial operating scenarios.

At step 620, the training computing system trains the neural network using the training examples to learn a correlation between the movement-pattern time series and one or more classification targets. In some embodiments, the neural network produces a binary output indicating whether the user equipment is associated with an unmanned aerial system. In some embodiments, the neural network additionally or alternatively produces one or more further binary outputs indicating whether the user equipment is airborne and whether the operation is beyond visual line of sight. In one non-limiting example, a shared backbone network feeds multiple output heads, each producing a respective probability. A loss function may include one or more binary cross-entropy terms, optionally weighted to account for class imbalance.

In some embodiments, the training data may be divided according to recording sessions such that data from a continuous flight session or terrestrial recording session is not split across training, validation, and test sets. The sessions may be stratified according to one or more factors such as unmanned-aerial-system type, altitude band, carrier frequency, radio band, geographic environment, or cell deployment type. Such session-based partitioning may reduce leakage of closely related sequential data across data subsets and may improve evaluation quality.

In some embodiments, the feature values may be normalized before training. For example, one or more continuous features may be standardized using training-set statistics, including a mean and standard deviation computed from the training data and stored for subsequent inference. One or more categorical features, such as a cell identifier or carrier-frequency identifier, may be represented using embeddings, look-up tables, one-hot encodings, or other suitable encodings. Binary indicators, including handover flags or validity-mask indicators, may be left unscaled or encoded separately.

In some embodiments, windows having more than a threshold proportion of missing samples may be discarded. For windows having no more than the threshold proportion of missing samples, one or more missing time steps may be filled with a selected substitute value, and a binary mask channel may be appended to indicate validity of the samples. In this manner, the neural network may distinguish valid measurements from missing measurements.

At step 630, the training computing system adjusts parameters of the neural network to reduce a classification loss. In some embodiments, the parameters are adjusted using backpropagation and a gradient-based optimizer, such as Adam or another stochastic optimizer. Example training hyperparameters may include a learning rate in a range from 1×10⁻⁴ to 1×10⁻³, a batch size in a range from 64 to 256, and early stopping based on validation performance, although other values may be used. Evaluation may include one or more of precision, recall, F1 score, area under a receiver operating characteristic curve, area under a precision-recall curve, probability of detection at selected false alarm rates, or threshold selection based on validation data.

In some embodiments, the disclosed model may be adapted across different environments, radio bands, carriers, or deployment conditions by transfer learning or fine tuning. By way of example, a network may first be trained on a source dataset representing multiple flight or terrestrial scenarios and may thereafter be fine tuned on a target environment by freezing one or more earlier layers and retraining one or more later layers or output layers at a lower learning rate. In some embodiments, performance may be monitored over time and retraining may be triggered when a selected metric deviates from a baseline by more than a threshold amount.

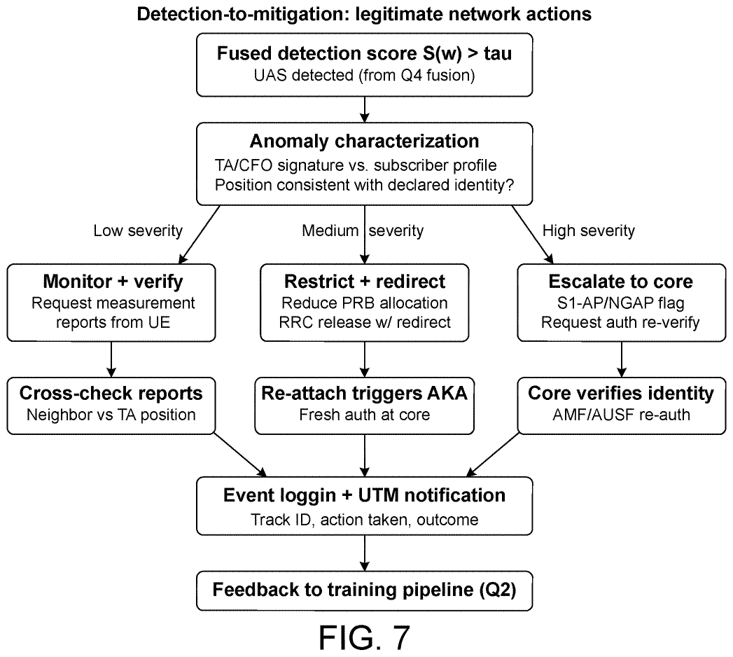

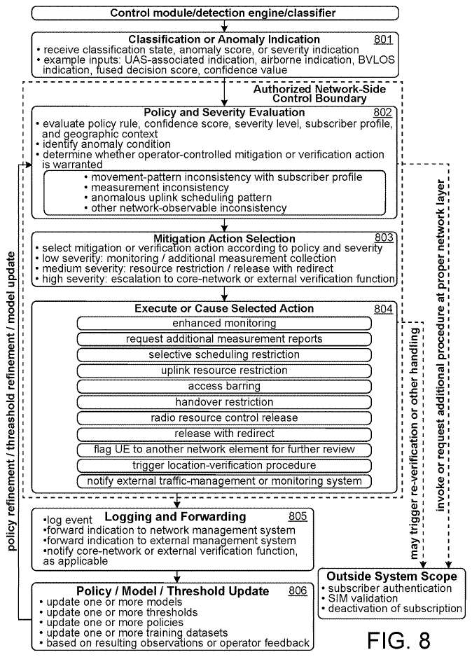

FIG. 7 illustrates, in an example embodiment, a method 700 of operation for a network-side mitigation process related to detection and tracking of a user equipment 102 associated with an unmanned aerial system in the cellular communication network 100. FIG. 8 illustrates, in an example embodiment, a scheme 800 for implementing the network-side mitigation process. In some embodiments, the mitigation process is performed by the control module 105 in conjunction with one or more radio access network functions and, in some embodiments, one or more core-network or external management functions.

At step 710, responsive to determining that a user equipment 102 is associated with an unmanned aerial system, airborne operation, or beyond visual line of sight operation, the control module 105 evaluates one or more anomaly conditions and selects a mitigation or verification action according to a policy rule, a confidence score, a severity level, a subscriber profile, a geographic context, or another operational criterion. By way of example, the anomaly conditions may include an inconsistency between a radio-derived movement pattern and an expected subscriber profile, an inconsistency between a reported measurement environment and a radio-derived position estimate, an anomalous uplink scheduling pattern, or another network-observable inconsistency.

At step 720, the control module 105 initiates or causes one or more operator-controlled mitigation or verification actions within the scope of the radio access network or associated network infrastructure. Such actions may include enhanced monitoring, requesting one or more additional measurement reports, selective scheduling restriction, uplink resource restriction, access barring, handover restriction, radio resource control release, release with redirect, flagging the user equipment to another network element for further review, triggering a location-verification procedure, or notifying an external traffic-management or monitoring system. In some embodiments, a low-severity condition may result in additional monitoring or measurement collection, a medium-severity condition may result in resource restriction or connection release with redirect, and a higher-severity condition may result in escalation to a core-network or external verification function.

In some embodiments, the disclosed system operates as a detection and policy-enforcement aid and does not itself perform subscriber authentication, SIM validation, or deactivation of a subscription. Instead, the disclosed system may identify network-observable anomalies and may invoke or request additional procedures at the appropriate network layer. For example, a release with redirect may cause the user equipment to reattach so that authentication is performed by the proper network function, or an anomaly indication may be sent to a core-network element for re-verification or other handling consistent with operator policy.

In some embodiments, the scheme 800 of FIG. 8 includes receiving a classification or anomaly indication 801, evaluating policy and severity conditions 802, selecting a mitigation action 803, executing or causing the selected action 804, logging an event or forwarding an indication to a network or external management system 805, and updating one or more models, thresholds, or training datasets based on resulting observations 806. The mitigation actions illustrated in FIG. 8 are non-limiting examples of actions that may be performed by network-side equipment within authorized operational boundaries.

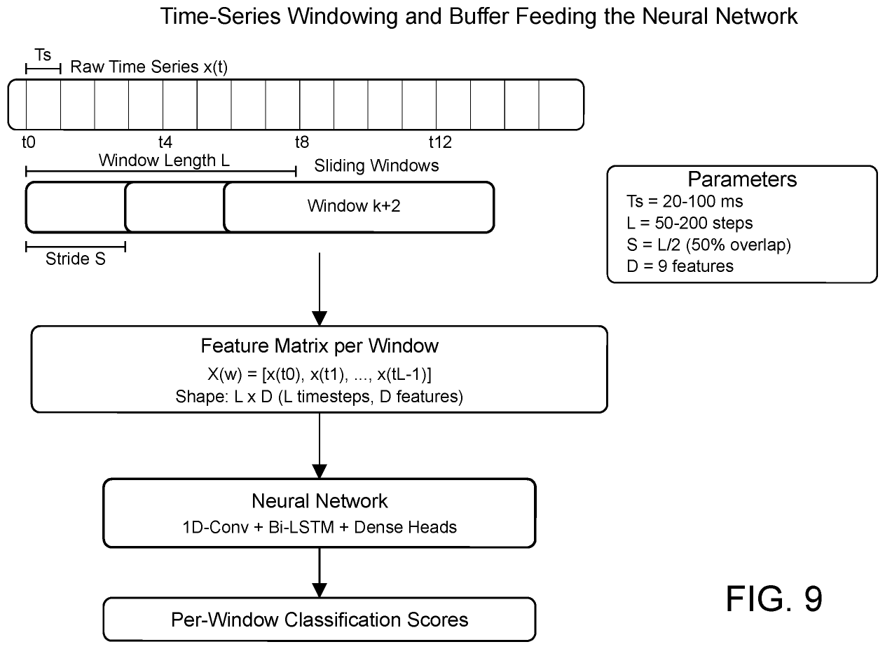

FIGS. 9-20 provide additional illustrative examples of movement-pattern time-series formation, feature construction, fusion, training, geometry-based estimation, handover continuity, tracking, deployment, and network-side mitigation. The examples associated with FIGS. 9-20 are non-limiting and may be implemented individually or in combination with the embodiments described with reference to FIGS. 1-8.

In some embodiments, FIG. 9 illustrates formation of input windows from a buffered movement-pattern time series. Feature vectors obtained at successive sampling intervals may be appended to a buffer and segmented into fixed-length windows or variable-length windows for inference. By way of non-limiting example, a sampling interval may be selected in a range from 20 milliseconds to 100 milliseconds, a window length may include from 50 to 200 time steps, and adjacent windows may overlap according to a selected stride. Each window may be represented as a feature matrix having a time dimension and a feature dimension and may be provided as an input to the trained neural network.

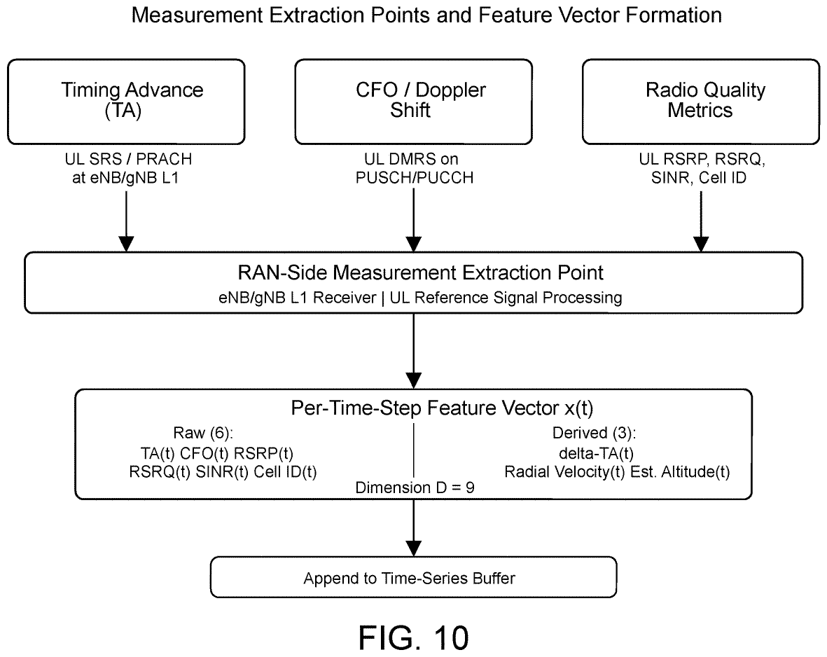

In some embodiments, FIG. 10 illustrates network-side measurement extraction points and per-time-step feature vector formation. Timing-related measurements may be obtained from uplink random access signals, sounding reference signals, demodulation reference signals, or other uplink reference signals at an eNB or gNB layer-1 receiver. Frequency-related measurements, including carrier frequency offset estimates and Doppler-related estimates, may likewise be obtained from uplink reference signals. Radio-quality metrics may include one or more of reference signal received power, reference signal received quality, signal-to-interference-plus-noise ratio, signal-to-noise ratio, a beam identifier, or a cell identifier. In some embodiments, the per-time-step feature vector includes raw measurements and one or more derived quantities, such as timing-advance change, radial velocity, range, range rate, altitude-related estimates, or acceleration-related estimates.

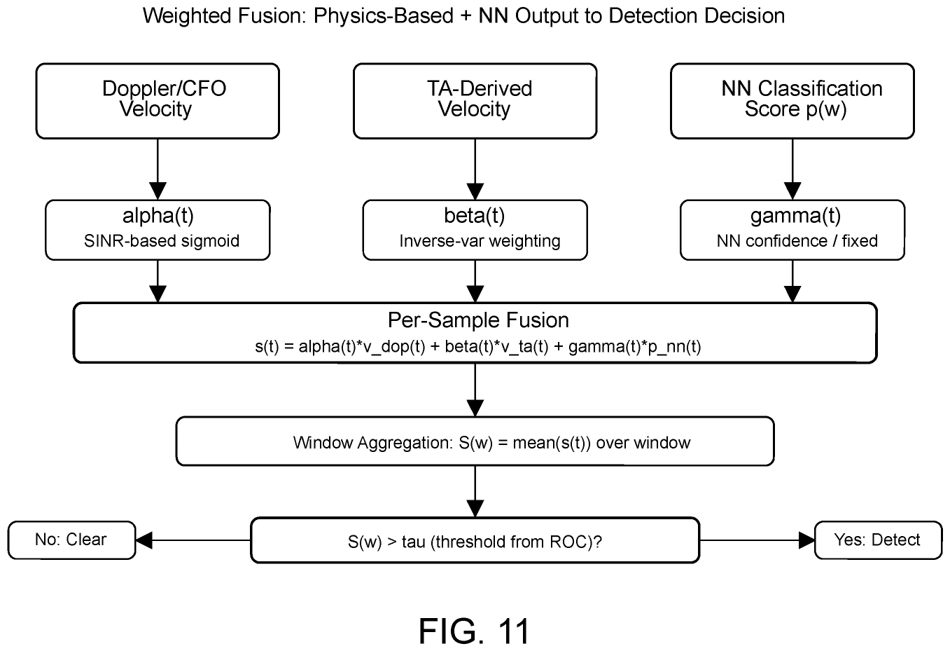

In some embodiments, FIG. 11 illustrates weighted fusion of one or more physics-based estimates and one or more outputs of the trained neural network. A timing-based estimate, such as a range-rate estimate derived from timing advance or timing-advance change, and a frequency-based estimate, such as a radial-velocity estimate derived from carrier frequency offset or Doppler information, may be combined with a neural-network score or probability. In some embodiments, confidence values for the respective sources are time-varying and are determined from one or more radio-quality metrics, estimated variances, handover status, or neural-network output confidence. A per-sample fused score may be aggregated across a window to generate a window score, and the window score may be compared with one or more thresholds to determine whether the user equipment is to be classified as associated with an unmanned aerial system, airborne, or operating beyond visual line of sight.

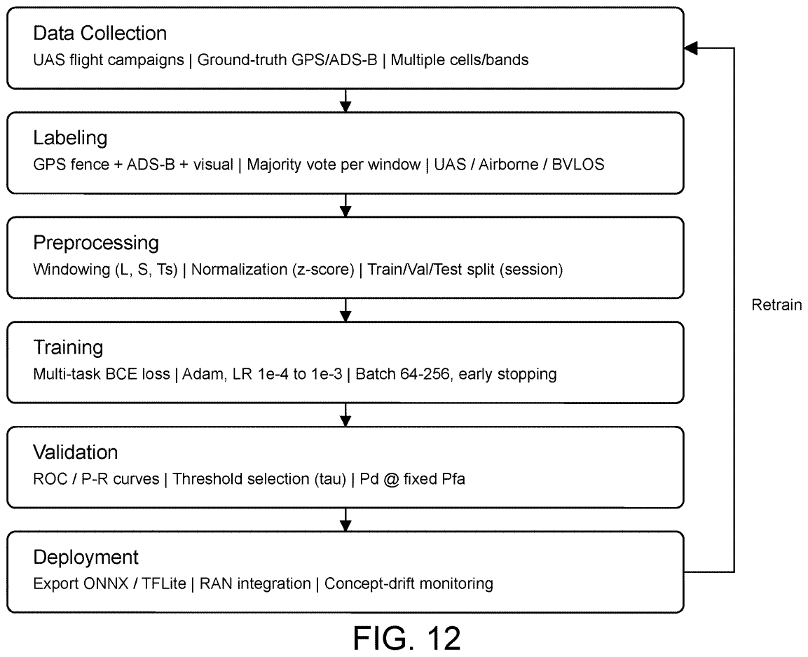

In some embodiments, FIG. 12 illustrates an end-to-end training pipeline for generating and deploying a trained neural network model. Training data may be collected from controlled unmanned aerial system flights and terrestrial user-equipment scenarios across multiple cells, carriers, or bands. Labels may be generated using one or more ground-truth sources, and movement-pattern time series may be segmented into windows, normalized, and divided into training, validation, and test sets according to recording sessions. The neural network may be trained using a selected optimizer and loss function, evaluated using one or more selected performance metrics, and deployed to a network-side inference environment. In some embodiments, post-deployment performance may be monitored, and retraining may be performed in response to concept drift or environmental changes.

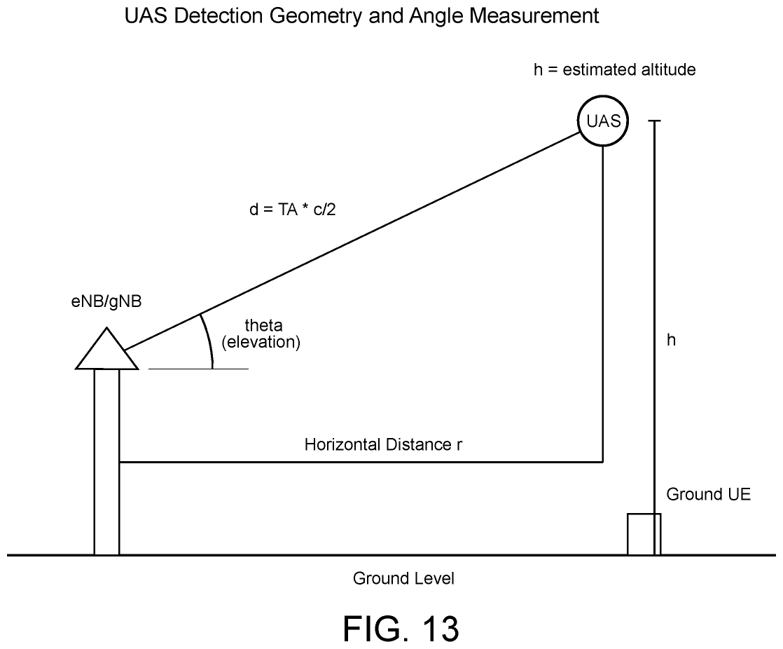

In some embodiments, FIG. 13 illustrates a geometry-based arrangement for estimating an altitude-related quantity of a user equipment relative to a base station. A slant range may be estimated from timing advance or another timing-based measurement, and an elevation-related quantity may be obtained from beam-management information, a beam index, antenna geometry, antenna electrical tilt, channel-state information, or another angle-related indicator. The estimated altitude-related quantity may be used as an input feature, as part of a fused decision metric, or as an observation provided to a tracking filter.

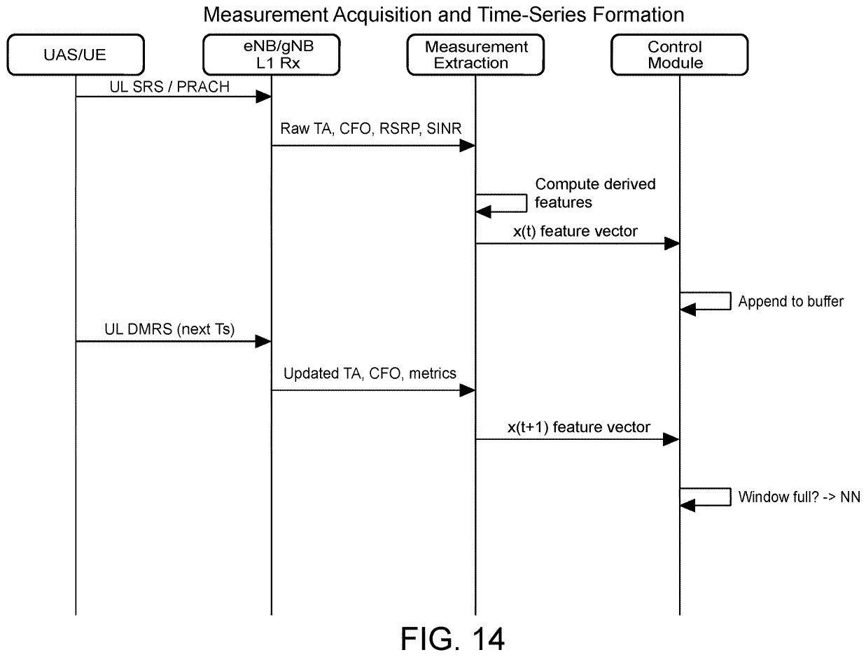

In some embodiments, FIG. 14 illustrates a call flow for measurement acquisition and movement-pattern time-series formation. Uplink transmissions from the user equipment may be received at a layer-1 receiver of a base station or other radio access network element, and raw measurements may be extracted at successive sampling intervals. The control module may derive one or more additional features, form a per-time-step feature vector, and append the feature vector to a time-series buffer. When a selected inference condition is satisfied, such as a buffer reaching a selected window length, the corresponding window may be provided to the trained neural network. In some embodiments, measurement collection and buffering behavior may depend on radio resource control state, such that a buffer may be paused, resumed, cleared, or reinitialized depending on availability of uplink measurements.

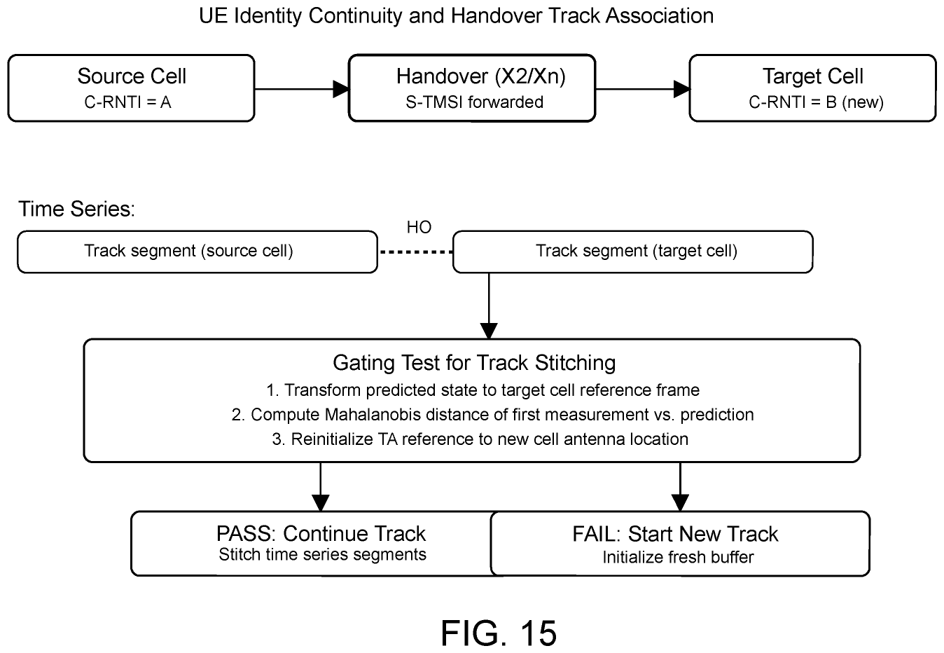

In some embodiments, FIG. 15 illustrates continuity of user-equipment identity and track association across handover between cells. A user equipment may be associated with a first cell-specific identifier before handover and a second cell-specific identifier after handover, while a broader temporary identity or forwarded mobility context is preserved across network elements. The control module may evaluate whether a post-handover measurement is sufficiently consistent with a predicted pre-handover track state by applying a gating test in a target-cell reference frame. If the gating test is satisfied, a track may be continued and a timing reference may be reinitialized relative to the target cell; otherwise, a new track or a new time-series buffer may be created.

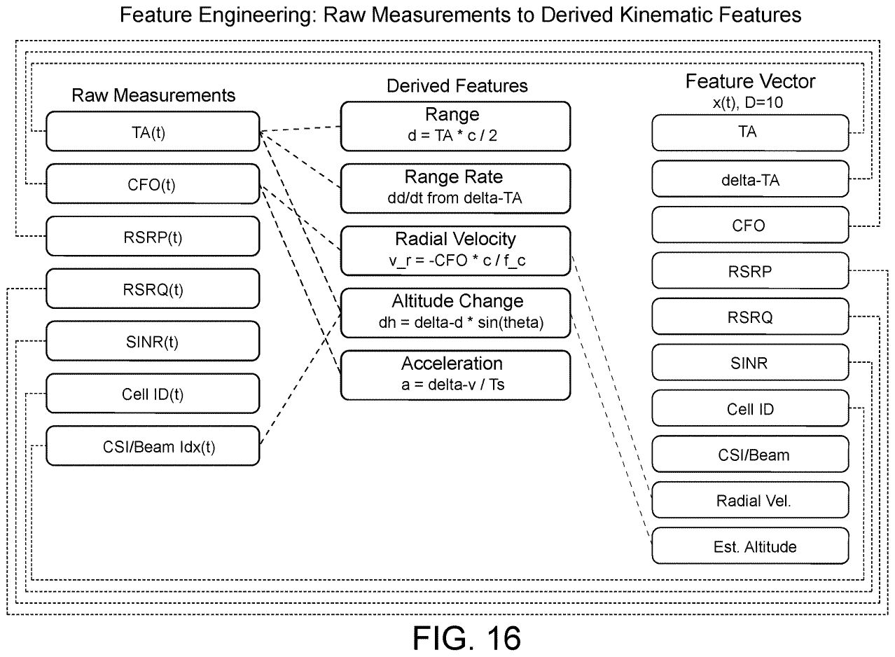

In some embodiments, FIG. 16 illustrates feature engineering from raw radio measurements to derived kinematic features. One or more raw measurements, such as timing advance, carrier frequency offset, radio-quality metrics, beam information, or cell identifiers, may be transformed into one or more derived quantities, such as range, range rate, radial velocity, altitude change, vertical velocity, or acceleration. The disclosed embodiments are not limited to any particular set of raw measurements or derived quantities, and different feature subsets may be used for different network configurations or model architectures.

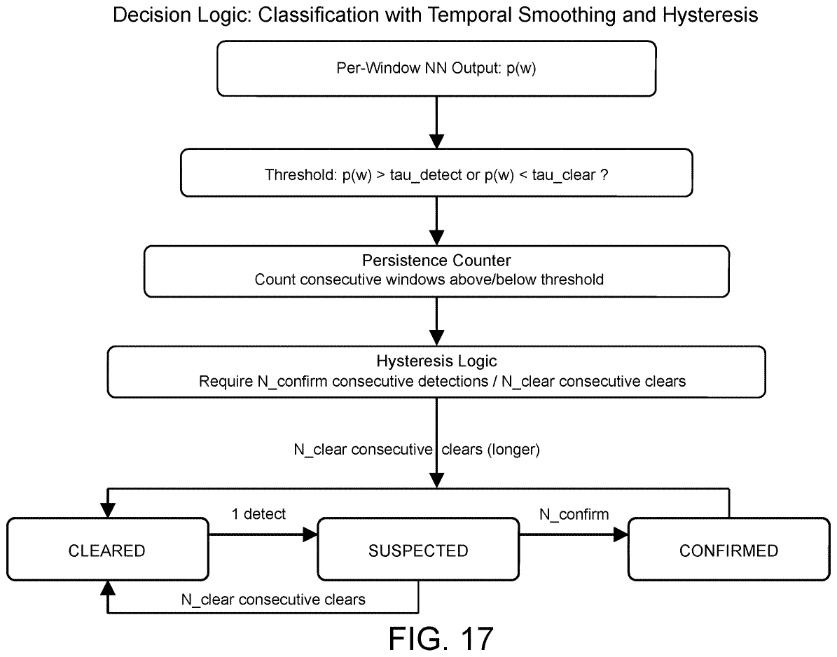

In some embodiments, FIG. 17 illustrates decision logic using temporal smoothing and hysteresis. A classification score produced for a current window may be compared with one or more detection thresholds or clearing thresholds, and one or more persistence counters may be updated according to recent window outcomes. A state machine may maintain, by way of example, cleared, suspected, and confirmed states, and state transitions may depend on persistence of detections or clears across multiple windows. Such logic may reduce false detections caused by transient radio fluctuations.

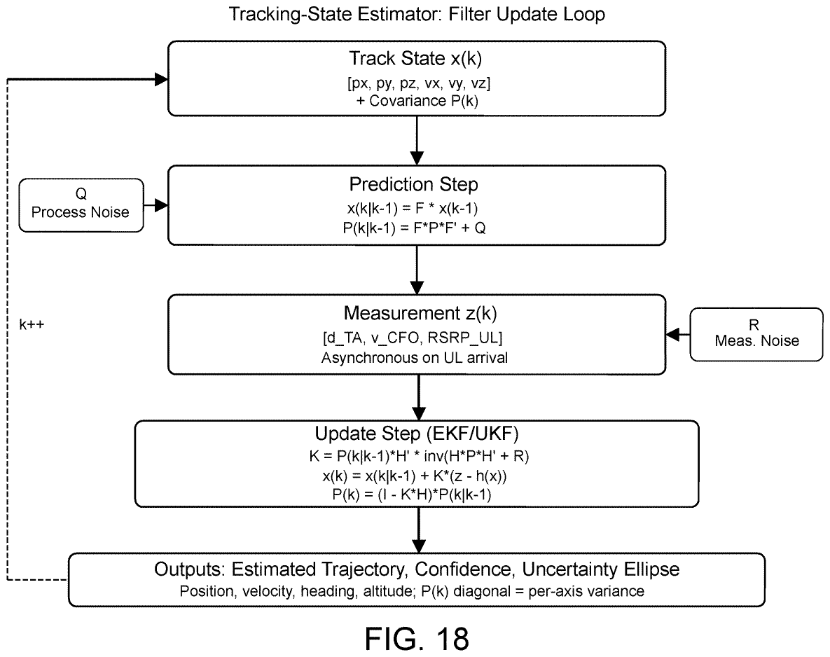

In some embodiments, FIG. 18 illustrates a tracking-state estimator update loop. A track state may include position, velocity, acceleration, or combinations thereof, and a prediction step may be performed according to a selected motion model. One or more radio-derived observations may be used in a subsequent update step, including one or more timing-based estimates, one or more frequency-based estimates, one or more received-power measurements, or combinations thereof. The state estimator may comprise a Kalman filter, an extended Kalman filter, an unscented Kalman filter, a particle filter, or another recursive estimator, and may output an estimated trajectory, confidence value, uncertainty value, or covariance quantity.

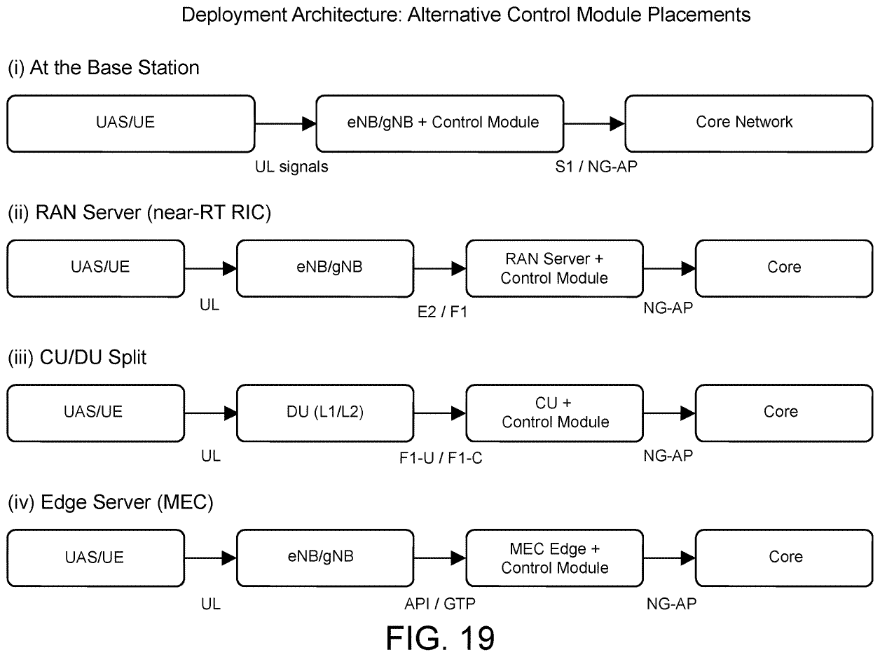

In some embodiments, FIG. 19 illustrates alternative deployment architectures for the network-side control module. By way of non-limiting example, the control module may be deployed at a base station, at a radio access network server, in a centralized-unit or distributed-unit arrangement, or at an edge-computing platform. Measurement extraction, time-series formation, neural-network inference, fusion, tracking, and mitigation operations may be performed at one location or distributed across multiple network-side elements under common control.

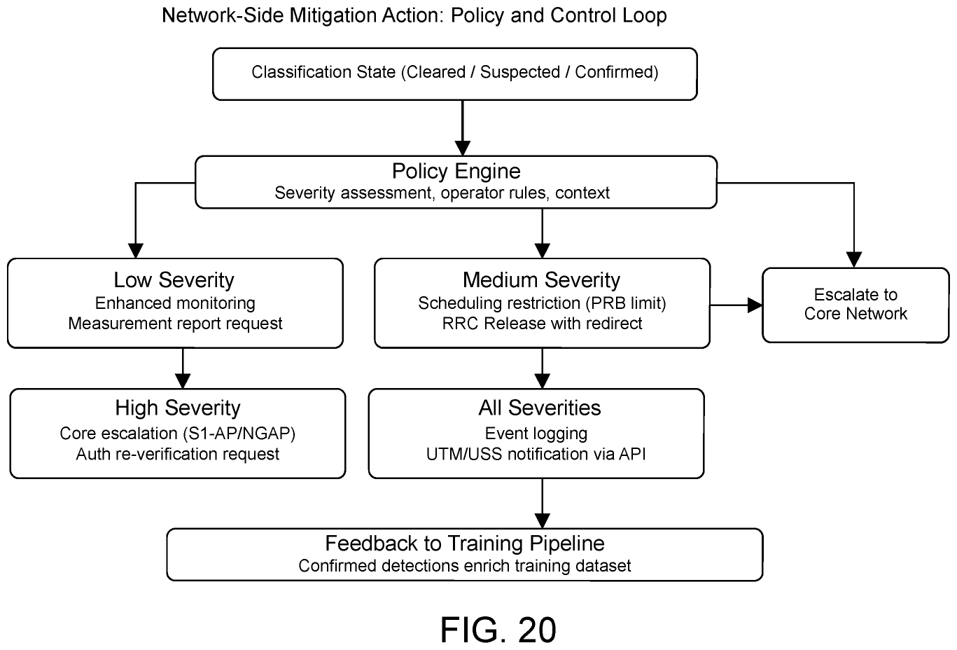

In some embodiments, FIG. 20 illustrates a network-side mitigation policy and control loop. A classification state, anomaly score, or severity indication may be provided to a policy engine that selects one or more operator-controlled actions. The actions may include enhanced monitoring, measurement report requests, scheduling restriction, uplink resource restriction, access blocking, handover restriction, radio resource control release, release with redirect, notification to another network element, notification to an external traffic-management or monitoring system, or combinations thereof. In some embodiments, resulting observations and operator feedback may be logged and used to update one or more thresholds, policies, models, or training datasets.

Although embodiments are described in detail herein with reference to the accompanying drawings, it is intended that disclosures herein not be limited to literal depictions of the embodiments illustrated by way of examples. As such, many modifications and equivalents of the machine learning based techniques of detecting and tracking BVLOS UAS's, and variations in sequence of the method steps in deployment thereof, will be apparent to practitioners skilled in the art. Accordingly, it is intended that the invention encompasses scope in accordance with the following claims and their equivalents. Furthermore, it is contemplated that a particular feature described either individually or as part of an embodiment can be combined with other individually described features, or portions of other embodiments described herein. Thus, absence of described particular combinations does not preclude the inventor from claiming rights to such combinations.

What is claimed is:

1. A computer-implemented method of detecting a beyond visual line of sight (BVLOS) unmanned aerial system (UAS) in a cellular communication network, the method comprising: monitoring, by one or more processors of a network-side control module, radio communications between a user equipment (UE) and a base station of the cellular communication network, the UE being camped on, registered with, or connected to the base station; obtaining, at each of a plurality of time instants and based at least in part on the radio communications, movement-related measurements associated with the UE; forming, by the network-side control module, a movement-pattern time series comprising a time-ordered sequence of feature vectors derived from the movement-related measurements; executing, by the network-side control module, a trained neural network using the movement-pattern time series as input to generate a classification output indicating whether the UE is associated with the BVLOS UAS; and classifying, by the network-side control module, the UE as associated with the BVLOS UAS based on the classification output.

2. The method of claim 1, wherein the cellular communication network comprises at least one of a Long Term Evolution (LTE) network and a Fifth Generation New Radio (5G-NR) network.

3. The method of claim 1, wherein determining the movement-related measurements comprises obtaining, from the radio communications, one or more measurements selected from timing advance (TA), a TA delta, a round-trip time, a carrier frequency offset (CFO), a Doppler shift estimate, a reference signal measurement, a beam index, a mobility indicator, a handover indicator, an uplink power control metric, an uplink power headroom metric, reference signal received power (RSRP), reference signal received quality (RSRQ), a signal-to-interference-plus-noise ratio (SINR), and a signal-to-noise ratio (SNR).

4. The method of claim 1, wherein each feature vector comprises at least one derived kinematic feature selected from range, range-rate, radial velocity, acceleration, altitude, vertical velocity, altitude change, and a velocity change.

5. The method of claim 1, wherein forming the movement-pattern time series comprises forming a sliding window comprising N sequential samples of the feature vectors, wherein N is at least 2.

6. The method of claim 5, wherein the sliding window comprises at least 10 samples and no more than 500 samples.

7. The method of claim 1, wherein executing the trained neural network comprises performing temporal modeling across the time-ordered sequence of feature vectors to identify temporal dependencies indicative of a movement pattern associated with the BVLOS UAS.

8. The method of claim 1, wherein the trained neural network comprises a sequence model selected from a long short-term memory (LSTM) network, a gated recurrent unit (GRU) network, a temporal convolutional network (TCN), and a transformer-based attention network.

9. The method of claim 1, wherein classifying the UE as associated with the BVLOS UAS comprises applying temporal smoothing or hysteresis by requiring persistence of the classification output across a plurality of sliding windows.

10. The method of claim 1, wherein the trained neural network comprises a convolutional neural network (CNN) and a sequence model, and wherein an output of the CNN is provided as an input to the sequence model.

11. The method of claim 10, wherein the sequence model comprises an LSTM network and the CNN performs one-dimensional convolutions over the feature vectors in the movement-pattern time series.

12. The method of claim 1, further comprising deriving, from a timing-based measurement obtained from the radio communications, a timing-based kinematic estimate indicative of a range or a range-rate of the UE relative to the base station.

13. The method of claim 12, wherein the timing-based measurement comprises timing advance (TA) and the timing-based kinematic estimate comprises a distance change or a range-rate derived from a TA delta.

14. The method of claim 1, further comprising deriving, from a frequency-based measurement obtained from the radio communications, a frequency-based kinematic estimate indicative of a radial velocity of the UE relative to the base station.

15. The method of claim 14, wherein the frequency-based measurement comprises a carrier frequency offset (CFO) and/or a Doppler shift estimate.

16. The method of claim 10, further comprising: generating a physics-based kinematic estimate based on at least two distinct radio measurement sources comprising a timing-based measurement and a frequency-based measurement; and generating a fused decision metric by combining the physics-based kinematic estimate and the classification output of the trained neural network, wherein classifying the UE as associated with the BVLOS UAS is based on the fused decision metric.

17. A radio access network server comprising: one or more processors; and a memory storing instructions that, when executed by the one or more processors, cause the radio access network server to perform operations comprising: monitoring radio communications between a user equipment (UE) and a base station of a cellular communication network, the UE being camped on, registered with, or connected to the base station; obtaining, at each of a plurality of time instants and based at least in part on the radio communications, movement-related measurements associated with the UE; forming a movement-pattern time series comprising a time-ordered sequence of feature vectors derived from the movement-related measurements; executing a trained neural network using the movement-pattern time series as input to generate a classification output indicating whether the UE is associated with a beyond visual line of sight (BVLOS) unmanned aerial system (UAS); and classifying the UE as associated with the BVLOS UAS based on the classification output.

18. The radio access network server of claim 17, wherein the cellular communication network comprises at least one of a Long Term Evolution (LTE) network and a Fifth Generation New Radio (5G-NR) network.

19. The radio access network server of claim 17, wherein the operations comprise performing temporal modeling across the movement-pattern time series to identify temporal dependencies indicative of a movement pattern associated with the BVLOS UAS.

20. The radio access network server of claim 17, wherein the trained neural network comprises a sequence model selected from an LSTM network, a GRU network, a TCN, and a transformer-based attention network.

21. The radio access network server of claim 17, wherein the trained neural network comprises a CNN and an LSTM, and wherein an output of the CNN is provided as an input to the LSTM.

22. The radio access network server of claim 17, wherein the operations further comprise deriving a timing-based kinematic estimate from timing advance (TA) and deriving a frequency-based kinematic estimate from a carrier frequency offset (CFO) and/or a Doppler shift estimate.

23. The radio access network server of claim 17, wherein the operations further comprise generating a fused decision metric by combining a physics-based kinematic estimate with the classification output of the trained neural network, and weighting the combining based on one or more confidence values derived from at least one radio signal quality metric selected from SINR, RSRP, and RSRQ.

24. The radio access network server of claim 17, wherein the operations further comprise, responsive to classifying the UE as associated with the BVLOS UAS, causing a network-side mitigation action selected from access barring, throttling, uplink resource restriction, handover restriction, radio resource control (RRC) release, and session termination.

25. A non-transitory computer-readable storage medium storing instructions that, when executed by one or more processors of a network-side control module, cause the one or more processors to perform operations comprising: monitoring radio communications between a user equipment (UE) and a base station of a cellular communication network, the UE being camped on, registered with, or connected to the base station; obtaining, at each of a plurality of time instants and based at least in part on the radio communications, movement-related measurements associated with the UE; forming a movement-pattern time series comprising a time-ordered sequence of feature vectors derived from the movement-related measurements; executing a trained neural network using the movement-pattern time series as input to generate a classification output indicating whether the UE is associated with a beyond visual line of sight (BVLOS) unmanned aerial system (UAS); and classifying the UE as associated with the BVLOS UAS based on the classification output.

26. The non-transitory computer-readable storage medium of claim 25, wherein executing the trained neural network comprises performing temporal modeling across the movement-pattern time series.

27. The non-transitory computer-readable storage medium of claim 25, wherein the trained neural network comprises a CNN and a sequence model, and wherein an output of the CNN is provided as an input to the sequence model.

28. The non-transitory computer-readable storage medium of claim 25, wherein the operations further comprise deriving timing advance (TA) and a carrier frequency offset (CFO) and/or a Doppler shift estimate from the radio communications and generating a fused decision metric by combining a physics-based kinematic estimate derived therefrom with the classification output.

29. A computer-implemented method of training a neural network for classifying a user equipment (UE) as associated with a beyond visual line of sight (BVLOS) unmanned aerial system (UAS) in a cellular communication network, the method comprising: obtaining, by one or more processors of a training computing system, training examples, each training example comprising a labeled movement-pattern time series derived from radio communications between a UE and a base station, each movement-pattern time series comprising a time-ordered sequence of feature vectors derived from movement-related measurements associated with the UE; and training, by the training computing system, the neural network using the training examples by adjusting weights of the neural network using backpropagation to reduce a classification loss.

30. The method of claim 29, wherein the labeled movement-pattern time series are labeled based on ground truth sources comprising at least one of controlled UAS flight telemetry, global navigation satellite system (GNSS) logs, inertial measurement unit (IMU) logs, cooperative UAS identifiers, and synchronized test range instrumentation, and wherein negative training examples comprise movement-pattern time series for non-UAS UEs operating in terrestrial scenarios.
